(19) United States
(12) Patent Application Publication
(10) Pub. No.: US 2008/0008378 A1
(43) Pub. Date: Jan. 10, 2008

(54) Arbitration system for determining the orientation of an envelope from a plurality of classifiers

(75) Inventors: Richard S. Andel, Binghamton, NY (US); Sean Corrigan, Endicott, NY (US); Rosemary D. Paradis, Vestal, NY (US); Kenei Suntarat, Endicott, NY (US); Dennis A. Tillotson, McDonough, NY (US)

Correspondence Address: TAROLLI, SUNDHEIM, COVELL & TUMMINO LLP, Suite 1700, 1300 East Ninth Street, CLEVELAND, OH, 44114, US

(73) Assignee: Lockheed Martin Corporation

(21) Appl. No.: 11/482,421

(22) Filed: Jul. 7, 2006

(51) Int. Cl. G06K 9/00; G06K 9/46; G06K 9/64; G06K 9/32; G06K 9/66

(52) U.S. Cl. 382/141; 382/190; 382/223; 382/294

(57) ABSTRACT

Systems and methods are provided for determining the orientation of an envelope. A plurality of classification elements are each operative to analyze at least one image of the envelope and produce at least one output value indicative of the orientation of the envelope. An arbitrator determines an associated orientation for the envelope according to the plurality of output values provided by the plurality of classification elements.

### BACKGROUND OF THE INVENTION

In mail handling application, a limited amount of time is available to make a decision about any one envelope inputted into the mail stream. For example, postal indicia (e.g., information on the envelope that is not part of the mailing address) and at least a portion of the address text on an envelope or package must be scanned, located, and recognized in a period on the order of one hundred milliseconds to maintain the flow of mail through the system. These time constraints limit the available solutions for accurately classifying various elements on an envelope.

The problem is further complicated by the fact that the orientation of the envelope in the mail handling system is not standard. While many systems maintain the envelope in a generally vertical (i.e., longest edge vertical) position, it is possible that the envelope will be rotated to a position opposite the standard orientation or flipped such that the back of the envelope is facing upwards. In these cases, the postal indicia to be identified may not be in the expected location.

### SUMMARY OF THE INVENTION

In accordance with one aspect of the present invention, a method is provided for determining the orientation of an envelope. An envelope image (front and back) is analyzed to produce a first output that is indicative of the orientation of the envelope. At least one postal indicia present on the envelope is located. The located at least one postal indicia is analyzed to produce a second output. An associated orientation of the envelope is determined according to the first output and the second output.

In accordance with another aspect of the present invention, a computer program product, operative in a data processing system and implemented on a computer readable medium, is provided for determining the orientation of an envelope. A plurality of classification elements are each operative to analyze at least one image of the envelope and produce at least one output value indicative of the orientation of the envelope. A neural network arbitrator determines an associated orientation for the envelope according to the plurality of output values provided by the plurality of classification elements.

In accordance with yet another aspect of the present invention, an arbitration system that determines an associated orientation of an envelope is provided. An image acquisition element produces a first envelope image, representing a first side of the envelope, and a second envelope image, representing a second side of the envelope. A first classification system classifies each of a plurality of regions of interest associated with the first and second envelope images to produce a set of output values for each region of interest representing the likelihood that the envelope contains information that is typical of the layout of standard envelope's data. A second |classification system classifies each of the first and second envelope to produce a set of output values for each envelope image representing possible orientations of the envelope. An arbitration |system receives the set of output values associated with each region of interest from the first classification system and the set of output values associated with each envelope image from the second classification system and determines an associated orientation for the envelope according to the received sets of output values from the first and second classifiers.

### BRIEF DESCRIPTION OF THE DRAWINGS

The foregoing and other features of the present invention will become apparent to one skilled in the art to which the present invention relates upon consideration of the following description of the invention with reference to the accompanying drawings, wherein:

FIG. 1 illustrates an orientation arbitration system in accordance with an aspect of the present invention;

FIG. 2 illustrates an exemplary artificial neural network classifier;

FIG. 3 illustrates an exemplary implementation of an orientation arbitration system in accordance with an aspect of the present invention;

FIG. 4 illustrates a methodology for determining the orientation of an envelope from the output of a plurality of pattern recognition classifiers in accordance with an aspect of the present invention;

FIG. 5 illustrates an exemplary mail handling system incorporating an orientation arbitration system in accordance with an aspect of the present invention;

FIG. 6 illustrates an exemplary image processing system for a mail handling system in accordance with an aspect of the present invention; and

FIG. 7 illustrates a computer system that can be employed to implement systems and methods described herein.

### DETAILED DESCRIPTION OF THE INVENTION

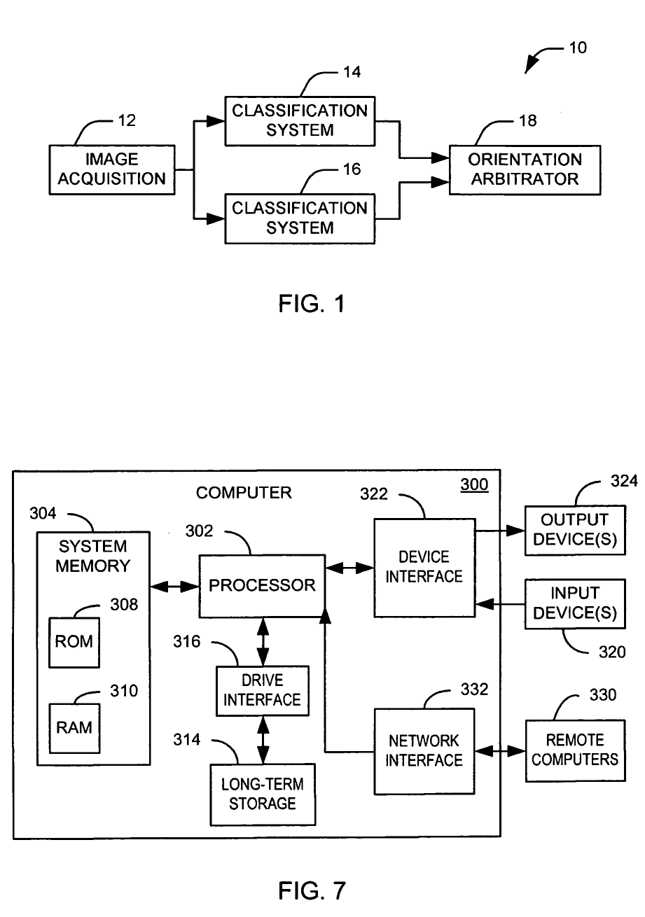

The present invention relates to systems and methods for efficient determination of the orientation of an envelope. FIG. 1 illustrates an orientation arbitration system 10 that identifies the orientation and facing of an envelope from the outputs of a plurality of other classification systems in accordance with an aspect of the present invention. For ease of reference, the term “orientation” is utilized herein to encompass both the orientation and facing of the envelope. It will be appreciated that knowledge of the orientation of the envelope allows for simplification of future analysis of the envelope image (e.g., optical character recognition of all or a portion of the address, postage verification, postal indicia detection and recognition etc.). In addition, once the envelope is oriented and faced, it is canceled and sprayed with an identification tag. In order to process the mail appropriately, the cancellation and the id tag need to be placed in the correct location on the envelope, requiring an accurate determination of the facing and orientation of each envelope.

To this end, the illustrated system 10 is designed to determine the orientation of an envelope in an extremely short period of time, generally on the order of tens of milliseconds. This is accomplished, at least in part, by utilizing outputs of upstream processes that have some bearing on the orientation of the envelope. For example, postal indicia classifiers can provide information concerning the location and identity of one or more postal indicia, which, since postal indicia tend to appear in predictable locations, provides information as to the orientation and facing of the envelope.

Accordingly, one or more images of the envelope are acquired for analysis at an image acquisition element 16. For example, in one implementation, respective lead and trail cameras on either side of a conveyer belt associated with the mail sorting system are used to take an image of each side of the envelope, such that a first image represents a front side of the envelope and second image represents a back side of the envelope. It will be appreciated that these images can comprise grayscale and color images of various resolutions, which can be utilized to generate binarized images of the envelope, in which each pixel is represented by a single bit as “dark” or “white”.

The acquired images are then provided to each of a plurality of classification systems 14 and 16 within the system 10. Each classification system extracts a plurality of numerical feature vectors from an image of both sides of the envelope and determines at least one characteristic of the envelope that is relevant to the orientation of the envelope. In an exemplary implementation, a first set of at least one of the plurality of classification systems (e.g., 14) locates and identifies postal indicia and a second set of at least one of the plurality of classification systems (e.g., 16) attempts to directly determine the orientation of the envelope. It will be appreciated, however, that neither set of classification systems is necessary in an implementation of an arbitration system in accordance with an aspect of the present invention. Further, other classification systems having outputs relevant to the orientation of the envelope can be utilized in place of or in addition to the specified examples.

The respective outputs of the plurality of classification systems 14 and 16 are provided to an orientation arbitration system 18. The arbitration system determines an associated orientation for the envelope from a plurality of possible orientations according to the outputs of the plurality of classification systems 14 and 16. In an exemplary implementation, envelopes are maintained in a vertical position (i.e., longest edge vertical) while they are on a conveyor belt within a mail handling system. In this arrangement, the envelope can only assume one of four possible positions. Specifically, the envelope can be in a “normal” orientation, where the front of the envelope faces the lead camera and the address reads from the bottom of the envelope to the top, rotated one hundred eighty degrees, flipped to where the back of the envelope faces the lead camera, or both flipped to the back side and rotated one hundred eighty degrees.

The orientation arbitration system 18 can include one or more classifiers of various types including statistical classifiers, neural network classifiers, and self-organizing maps that have been designed or adapted to determine an appropriate orientation for the envelope according to the outputs of the plurality of classification systems 14 and 16. In an exemplary implementation, the orientation arbitration system 18 can include an artificial neural network classifier. A neural network is composed of a large number of highly interconnected processing elements that have weighted connections. It will be appreciated that these processing elements can be implemented in hardware or simulated in software. The organization and weights of the connections determine the output of the network, and are optimized via a training process to reduce error and generate the best output classification.

The outputs of the plurality of classification systems 14 and 16 can be provided to the inputs of the neural network, and a set of output values corresponding to the plurality of output classes is produced at the neural network output. Each of the set of output values represent the likelihood that the candidate image falls within the orientation class associated with the output value. The orientation class having the optimal output value is selected. What constitutes an optimal value will depend on the design of the neural network. In one example, the output class having the largest output value is selected.

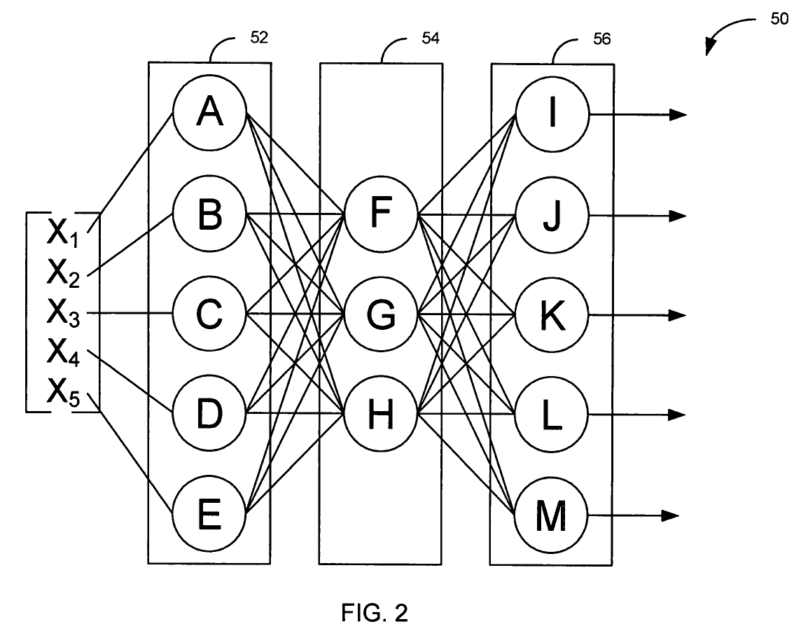

FIG. 2 illustrates an exemplary artificial neural network classifier 50. The illustrated neural network is a three-layer back-propagation neural network suitable for use in an elementary pattern classifier. It should be noted here, that the neural network illustrated in FIG. 2 is a simple example solely for the purposes of illustration. Any non-trivial application involving a neural network, including pattern classification, would require a network with many more nodes in each layer and/or additional hidden layers. It will further be appreciated that a neural network can be implemented in hardware as a series of interconnected hardware processors or emulated as part of a software program running on a data processing system.

In the illustrated example, an input layer 52 comprises five input nodes, A-E. A node, or neuron, is a processing unit of a neural network. A node may receive multiple inputs from prior layers which it processes according to an internal formula. The output of this processing may be provided to multiple other nodes in subsequent layers. The functioning of nodes within a neural network is designed to mimic the function of neurons within a human brain.

Each of the five input nodes A-E receives input signals with values relating to features of an input pattern. Preferably, a large number of input nodes will be used, receiving signal values derived from a variety of pattern features. Each input node sends a signal to each of three intermediate nodes F-H in a hidden layer 54. The value represented by each signal will be based upon the value of the signal received at the input node. It will be appreciated, of course, that in practice, a classification neural network can have a number of hidden layers, depending on the nature of the classification task.

Each connection between nodes of different layers is characterized by an individual weight. These weights are established during the training of the neural network. The value of the signal provided to the hidden layer 54 by the input nodes A-E is derived by multiplying the value of the original input signal at the input node by the weight of the connection between the input node and the intermediate node (e.g., G). Thus, each intermediate node F-H receives a signal from each of the input nodes A-E, but due to the individualized weight of each connection, each intermediate node receives a signal of different value from each input node. For example, assume that the input signal at node A is of a value of 5 and the weights of the connections between node A and nodes F-H are 0.6, 0.2, and 0.4 respectively. The signals passed from node A to the intermediate nodes F-H will have values of 3, 1, and 2.

Each intermediate node F-H sums the weighted input signals it receives. This input sum may include a constant bias input at each node. The sum of the inputs is provided into a transfer function within the node to compute an output. A number of transfer functions can be used within a neural network of this type. By way of example, a threshold function may be used, where the node outputs a constant value when the summed inputs exceed a predetermined threshold. Alternatively, a linear or sigmoidal function may be used, passing the summed input signals or a sigmoidal transform of the value of the input sum to the nodes of the next layer.

Regardless of the transfer function used, the intermediate nodes F-H pass a signal with the computed output value to each of the nodes I-M of the output layer 56. An individual intermediate node (i.e. G) will send the same output signal to each of the output nodes I-M, but like the input values described above, the output signal value will be weighted differently at each individual connection. The weighted output signals from the intermediate nodes are summed to produce an output signal. Again, this sum may include a constant bias input.

Each output node represents an output class of the classifier. The value of the output signal produced at each output node is intended to represent the probability that a given input sample belongs to the associated class. In the exemplary system, the class with the highest associated probability is selected, so long as the probability exceeds a predetermined threshold value. The value represented by the output signal is retained as a confidence value of the classification.

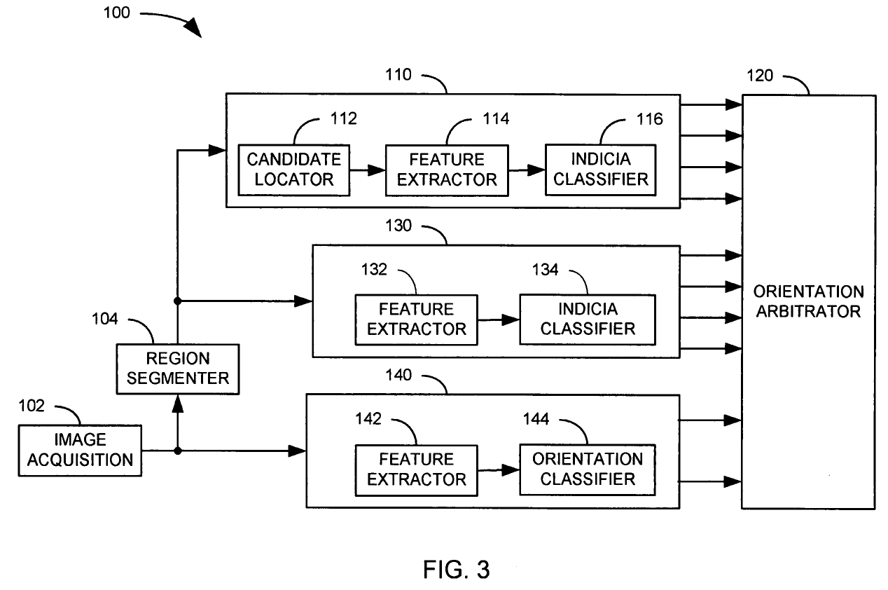

FIG. 3 illustrates an exemplary implementation of an orientation arbitration system 100 in accordance with an aspect of the present invention. It will be appreciated that in the illustrated implementation, envelopes are maintained in a vertical position (i.e., longest edge vertical) while they are on a conveyor belt within a mail handling system, but the orientation and facing of the envelope is otherwise unknown. In this arrangement, the envelope can only assume one of four possible positions. Specifically, the envelope can be in a “normal” orientation, where the front of the envelope faces the lead camera and the address reads from the bottom of the envelope to the top, rotated one hundred eighty degrees, flipped to where the back of the envelope faces the lead camera, or both flipped to the back side and rotated one hundred eighty degrees. The illustrated system relies upon inputs from previous classification processes in the mail handling system to efficiently determine an orientation associated with the envelope.

To this end, one or more images of the envelope are acquired for analysis at an image acquisition element 102. For example, in one implementation, respective lead and trail cameras on either side of a conveyer belt associated with the mail sorting system are used to take an image of each side of the envelope, such that a first image represents a the lead camera output and second image represents a trail camera output. It will be appreciated that these images can comprise grayscale and color images of various resolutions that can be binarized such that each pixel is represented by a single bit as “dark” or “white”.

The first and second envelope images can be provided to a region segmenter 104 that isolates a plurality of regions of interest from the first and second envelope images. The plurality of regions of interest are selected to represent positions in which indicia are expected to appear. According to postal standards, postage indicia (e.g., stamps, metermarks, etc.) can be found in a specific corner of the front side envelope. Accordingly, given the four possible orientations of the envelope, the corner of the envelope associated with postal indicia can only appear in one of four positions. To take advantage of this, the regions of interest can include the upper left corner and the lower right corner of the first image, and the upper right corner and the lower left corner of the second image. Accordingly, regions of interest from the original images can be isolated for indicia recognition.

The isolated regions of interest are provided to a first classification system 110 at a candidate locator 112 that locates possible indicia within each region of interest. The candidate locator 112 can scan each region of interest for dense regions of dark pixels that may be indicative of the presence of postal indicia within the region. In the illustrated implementation, a horizontal projection is performed across the region of interest to obtain a count of the number of dark pixels in each row of pixels. Once the total count for each row of pixels has been determined, the count for each row of pixels is compared to a horizontal count threshold value. When a sufficiently large number of sequential or nearly sequential rows having a number of dark pixels greater than the threshold are located, a dense regions is defined to encompass.

For every dense region that is found, a vertical projection is performed over the dense region. Accordingly, the number of dark pixels in each column of the dense region is determined and compared to a vertical count threshold. The candidate locator 112 looks for series of consecutive or nearly consecutive columns having a number of dark pixels greater than a threshold value, and saves any such regions found as candidate objects.

A located dense region, if any, for each of the regions of interest is provided to a feature extractor 114 that extracts numerical features from the identified candidate objects. The feature extractor 114 derives a vector of numerical measurements, referred to as feature variables, from the candidate object. In an exemplary implementation, a plurality of feature vector values can be determined by superimposing the candidate object on a white space of standard size, and dividing the whitespace into one hundred forty-four regions. A pixel count can be calculated for each of the regions and divided by an area of the region (in pixels) to obtain a pixel density for the region. The pixel densities for the one hundred forty-four regions can each be utilized as a numerical feature values within the feature vector. Another feature set can be derived by counting horizontal pixel runs within the candidate object. The feature extractor 114 starts at a first row of the candidate object and begins counting consecutive dark pixels each time a run of consecutive dark pixels are encountered. The length of each run of pixels is recorded as part of a histogram that can be utilized as the second set of feature values.

The extracted feature vector is then provided to an indicia classification system 116. The indicia classification system 116 can include one or more classifiers of various types including statistical classifiers, neural network classifiers, and self-organizing maps that have been designed or adapted to distinguish among the various postal indicia according to the features associated with the feature extractor 114. The classification system 116 calculates an output value for each of a plurality of output classes representing different types of postal indicia according to the extracted feature vector. In the illustrated implementation, the plurality of output classes includes classes representing metermarks, business reply mail markings, information based indicia (e.g., bar codes), stamps, blank regions, and a generic “other” class. It will be appreciated that the classification system 116 can be operative to provide a set of output values for each of the four regions of interest. Accordingly, for each region of interest, a set of six output values representing the six output classes will be provided to an orientation arbitrator 120 for analysis.

The isolated regions of interest are also provided to a second classification system 130 that identifies broad classes of postal indicia within the regions of interest. Each isolated region of the envelope image is provided to a feature extractor 132 that extracts numerical feature values from the isolated region of interest. For example, in an exemplary implementation, the feature values are determined by dividing the candidate image into a plurality of regions. Each region is further subdivided into 2-pixel by 2-pixel squares, with each 2-pixel by 2-pixel square representing one of a plurality of possible pixel patterns. The number of squares exhibiting each of the plurality of pixel patterns in a given region can be totaled by the system, and the total for each pattern within each region can be used as a feature value.

The extracted feature vector is then provided to an indicia classification system 134. The indicia classification system 134 can include one or more classifiers of various types including statistical classifiers, neural network classifiers, and self-organizing maps that have been designed or adapted to distinguish among the various postal indicia according to the features associated with the feature extractor 132. The classification system 134 calculates an output value for each of a plurality of output classes representing different types of postal indicia according to the extracted feature vector. In the illustrated implementation, the plurality of output classes includes classes representing metermarks, business reply mail markings, information based indicia (e.g., bar codes), stamps, blank regions, and a generic “other” class. The classification system 132 provides a set of output values representing these classes for each of the four regions of interest, such that a total of twenty-four output values are provided to the orientation arbitrator 120 from the second classification system 130.

A third classification system 140 receives images of each side of the envelope in its entirety. The two envelope images are provided to a feature extractor 142 that extracts features from the envelopes. The feature extractor 142 derives a vector of numerical measurements, referred to as feature variables, from each envelope image. In an exemplary implementation, a given envelope image is divided into a plurality of regions, and the number of dark pixels in each region is counted. This value is then divided by the area of the region to obtain a pixel density for the region. A feature vector representing the image can be generated from the plurality of pixel density values.

An extracted feature vector representing each region is provided to an orientation classification system 144. The orientation classification system 144 classifies each envelope image to determine an associated orientation for the envelope from a plurality of possible orientations. The orientation classification system 144 can include one or more classifiers of various types including statistical classifiers, neural network classifiers, and self-organizing maps that have been designed or adapted to determine an appropriate orientation for the envelope according to the feature values generated by the feature extractor 142.

In one implementation, the first and second images are classified separately, such that for each image an output value representing an arbitrary “default” front-facing orientation class, a front-facing orientation class that represents a rotation of one hundred eighty degrees from the default orientation, and a back-facing class is calculated. The three output values associated with each image are then provided to the classification arbitrator 120.

The classification arbitrator 120 determines an associated orientation for the envelope associated to the outputs of the first, second, and third classification systems 110, 130, and 140. In accordance with an aspect of the present invention, the classification arbitrator 120 can be implemented as a neural network having fifty-four input nodes that receive the outputs of the first, second, and third classification systems 110, 130, and 140 and outputs four output values indicating, respectively, the likelihood that the envelope is in one of the four possible orientations. The output class having the largest associated value is selected to provide an orientation and facing for the envelope.

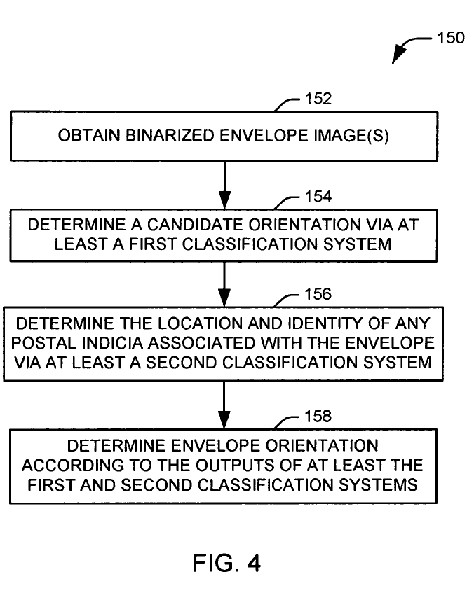

In view of the foregoing structural and functional features described above, methodology in accordance with various aspects of the present invention will be better appreciated with reference to FIG. 4. While, for purposes of simplicity of explanation, the methodology of FIG. 4 is shown and described as executing serially, it is to be understood and appreciated that the present invention is not limited by the illustrated order, as some aspects could, in accordance with the present invention, occur in different orders and/or concurrently with other aspects from that shown and described herein. Moreover, not all illustrated features may be required to implement a methodology in accordance with an aspect the present invention.

FIG. 4 illustrates a methodology 150 for determining the orientation of an envelope in accordance with an aspect of the present invention. The process begins at step 152, where at least binarized image of an envelope is acquired. In an exemplary implementation, respective lead and trail cameras on either side of a conveyer belt associated with a mail sorting system are used to take an image of each side of the envelope, such that a first image represents a front side of the envelope and second image represents a back side of the envelope. These images can then be binarized, such that every pixel is represented by a single bit as either “light” or “dark.”

At step 154, a candidate orientation for the envelope is determined via at least a first classification system. For example, the entirety of each side of the envelope can be examined to find regions of increased dark pixel density, which indicate indicia or text on the envelope surface. Since indicia and text tend to appear at predictable locations on the envelope, the first classification system can be trained to determine a candidate orientation for the envelope from the pixel density data. It will be appreciated that multiple classifiers can be utilized to determine respective candidate orientations, and that all of the determined candidate orientations can be utilized in determining a final orientation for the envelope in accordance with the illustrated methodology 150.

At step 156, the location and identity of one or more postal indicia associated with the envelope is determined via at least a second classification system. Each classification system can examine one or more regions of interest in the envelope images to detect the presence of postal indicia within the region. When a possible indicia is found, it is identified by the system as one of a plurality of broad categories of indicia. It will be appreciated that since postal indicia tend to be found in predictable locations on an envelope, the presence of postal indicia at a particular location provides information about the orientation of the envelope. It will be appreciated that multiple classifiers can be utilized to locate and classify postal indicia, and that the output of all of these classifiers can be utilized in determining a final orientation for the envelope in accordance with the illustrated methodology 150.

At step 158, an orientation for the envelope is determined according to at least the outputs of the first and second classification systems. In an exemplary implementation, the orientation of the envelope is determined as part of a pattern recognition routine, with the outputs of at least the first and second classification systems providing an input to the pattern recognition routine, and the output of the pattern recognition routine identifying one of a plurality of orientation classes that represent the orientation of the envelope. Once an associated orientation of the envelope has been determined, the determined orientation can be provided to one or more downstream processing components of the mail handling system.

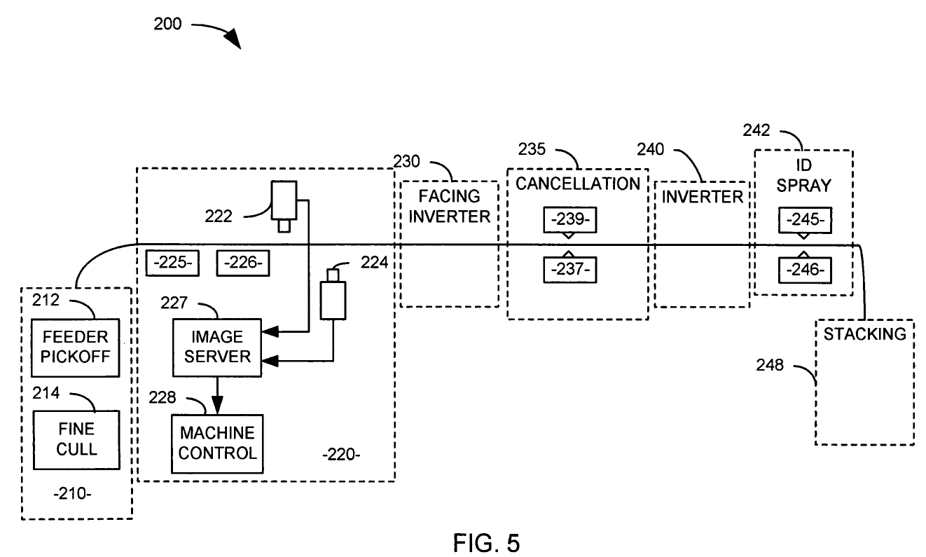

FIG. 5 illustrates an exemplary mail handling system 200 incorporating an orientation arbitration system in accordance with an aspect of the present invention. The mail sorting system 200 comprises a singulation stage 210, an image lifting stage 220, a facing inversion stage 230, a cancellation stage 235, an inversion stage 240, an ID tag spraying stage 242, and a stacking stage 248. One or more conveyors (not shown) would move mailpieces from stage to stage in the system 200 (from left to right in FIG. 5) at a rate of approximately 3.6-4.0 meters per second.

A singulation stage 210 includes a feeder pickoff 212 and a fine cull 214. The feeder pickoff 212 would generally follow a mail stacker (not shown) and would attempt to feed one mailpiece at a time from the mail stacker to the fine cull 214, with a consistent gap between mailpieces. The fine cull 214 would remove mailpieces that were too tall, too long, or perhaps too stiff. When mailpieces left the fine cull 214, they would be in fed vertically (e.g., longest edge parallel to the direction of motion) to assume one of four possible orientations.

The image lifting station 220 can comprise a pair of camera assemblies 222 and 224. As shown, the image lifting stage 220 is located between the singulation stage 210 and the facing inversion stage 230 of the system 200, but image lifting stage 220 may be incorporated into system 200 in any suitable location.

In operation, each of the camera assemblies 222 and 224 acquires both a low-resolution UV image and a high-resolution grayscale image of a respective one of the two faces of each passing mailpiece. Because the UV images are of the entire face of the mailpiece, rather than just the lower one inch edge, there is no need to invert the mailpiece when making a facing determination.

Each of the camera assemblies illustrated in FIG. 5 is constructed to acquire both a low-resolution UV image and a high-resolution grayscale image, and such assemblies may be used in embodiments of the invention. It should be appreciated, however, the invention is not limited in this respect. Components to capture a UV image and a grayscale image may be separately housed in alternative embodiments. It should be further appreciated that the invention is not limited to embodiments with two or more camera assemblies as shown. A single assembly could be constructed with an opening through which mailpieces may pass, allowing components in a single housing to form images of multiple sides of a mailpiece. Similarly, optical processing, such as through the use of mirrors, could allow a single camera assembly to capture images of multiple sides of a mailpiece.

Further, it should be appreciated that UV and grayscale are representative of the types of image information that may be acquired rather than a limitation on the invention. For example, a color image may be acquired. Consequently, any suitable imaging components may be included in the system 200.

As shown, the system 200 may further include an item presence detector 225, a belt encoder 226, an image server 227, and a machine control computer 228. The item presence detector 225 (exemplary implementations of an item presence detector can include a “photo eye” or a “light barrier”) may be located, for example, five inches upstream of the trail camera assembly 222, to indicate when a mailpiece is approaching. The belt encoder 226 may output pulses (or “ticks”) at a rate determined by the travel speed of the belt. For example, the belt encoder 226 may output two hundred and fifty six pulses per inch of belt travel. The combination of the item presence detector 225 and belt encoder 226 thus enables a relatively precise determination of the location of each passing mailpiece at any given time. Such location and timing information may be used, for example, to control the strobing of light sources in the camera assemblies 222 and 224 to ensure optimal performance independent of variations in belt speed.

Image information acquired with the camera assemblies 222 and 224 or other imaging components may be processed for control of the mail sorting system or for use in routing mailpieces passing through the system 200. Processing may be performed in any suitable way with one or more processors. In the illustrated embodiment, processing is performed by image server 227. It will be appreciated that, in one implementation, an orientation arbitration system in accordance with an aspect of the present invention, could be implemented as a software program in the image server 227.

The image server 227 may receive image data from the camera assemblies 222 and 224, and process and analyze such data to extract certain information about the orientation of and various markings on each mailpiece. In some embodiments, for example, images may be analyzed using one or more neural network classifiers, various pattern analysis algorithms, rule based logic, or a combination thereof. Either or both of the grayscale images and the UV images may be so processed and analyzed, and the results of such analysis may be used by other components in the system 200, or perhaps by components outside the system, for sorting or any other purpose.

In the embodiment shown, information obtained from processing images is used for control of components in the system 200 by providing that information to a separate processor that controls the system. The information obtained from the images, however, may additionally or alternatively be used in any other suitable way for any of a number of other purposes. In the pictured embodiment, control for the system 200 is provided by a machine control computer 228. Though not expressly shown, the machine control computer 228 may be connected to any or all of the components in the system 200 that may output status information or receive control inputs. The machine control computer 228 may, for example, access information extracted by the image server 227, as well as information from other components in the system, and use such information to control the various system components based thereupon.

In the example shown, the camera assembly 222 and 224 is called the “lead” assembly because it is positioned so that, for mailpieces in an upright orientation, the indicia (in the upper right hand corner) is on the leading edge of the mailpiece with respect to its direction of travel. Likewise, the camera assembly 224 is called the “trail” assembly because it is positioned so that, for mailpieces in an upright orientation, the indicia is on the trailing edge of the mailpiece with respect to its direction of travel. Upright mailpieces themselves are also conventionally labeled as either “lead” or “trail” depending on whether their indicia is on the leading or trailing edge with respect to the direction of travel.

Following the last scan line of the lead camera assembly 222, the image server 227 may determine an orientation of “flip” or “no-flip” for the facing inverter 230. In particular, the inverter 230 is controlled so that that each mailpiece has its top edge down when it reaches the cancellation stage 235, thus enabling one of the cancellers 237 and 239 to spray a cancellation mark on any indicia properly affixed to a mailpiece by spraying only the bottom edge of the path (top edge of the mailpiece). The image server 227 may also make a facing decision that determines which canceller (lead 237 or trail 239) should be used to spray the cancellation mark. Other information recognized by the image server 227, such as information based indicia (IBI), may also be used, for example, to disable cancellation of IBI postage since IBI would otherwise be illegible downstream.

After cancellation, all mailpieces may be inverted by the inverter 242, thus placing each mailpiece in its upright orientation. Immediately thereafter, an ID tag may be sprayed at the ID spraying stage 244 using one of the ID tag sprayers 245 and 246 that is selected based on the facing decision made by the image server 227. In some embodiments, all mailpieces with a known orientation may be sprayed with an ID tag. In other embodiments, ID tag spraying may be limited to only those mailpieces without an existing ID tag (forward, return, foreign).

Following application of ID tags, the mailpieces may ride on extended belts for drying before being placed in output bins or otherwise routed for further processing at the stacking stage 248. Except for rejects, the output bins can be placed in pairs to separate lead mailpieces from trail mailpieces. It is desirable for the mailpieces in each output bin to face identically. The operator may thus rotate trays properly so as to orient lead and trail mailpieces the same way. The mail may be separated into four broad categories: (1) facing identification marks (FIM) used with a postal numeric encoding technique, (2) outgoing (destination is a different sectional center facility (SCF)), (3) local (destination is within this SCF), and (4) reject (detected double feeds, not possible to sort into other categories). The decision of outgoing vs. local, for example, may be based on the image analysis performed by the image server 227.

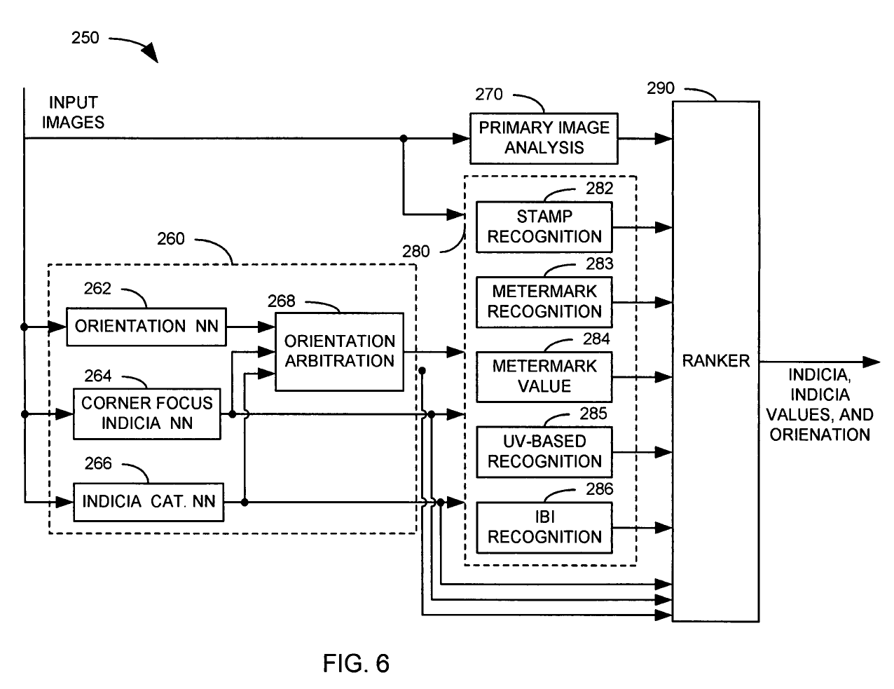

FIG. 6 illustrates an exemplary image processing system 250 for a mail handling system in accordance with an aspect of the present invention. The image processing system 250 can be roughly divided into two sequential stages. In a first stage, the orientation and facing of the envelope are determined as well as general information relating to the types of indicia located on the envelope. During the first processing stage, an orientation determination element 260, comprising an orientation arbitration system in accordance with an aspect of the present invention, can be initiated to provide an initial determination of the orientation and facing of the envelope. In accordance with an aspect of the present invention, the first stage of image processing is designed to operate within less than one hundred eighty milliseconds.

One or more images can be provided to the orientation determination element 260 as part of the first processing stage. A plurality of neural network classifiers 262, 264, and 266 within the orientation determination element 260 are operative to analyze various aspects of the input images to determine an orientation and facing of the envelope. A first neural network classifier 262 determines an appropriate orientation for the envelope according to the distribution of dark pixels across each side of the envelope. A second neural network classifier 264 can comprise an indicia detection and recognition system that locates dense regions within the corners of an envelope and classifies the located dense regions into broad indicia categories. A third neural network classifier 266 can review information related to four different corners (two front and two back) to determine the presence and type, if present, of postal indicia within these regions.

In accordance with an aspect of the present invention, the outputs of all three neural network classifiers 262, 264, and 266 are provided to an orientation arbitrator 268. The orientation arbitrator 268 determines an associated orientation and facing for the envelope according to the neural network outputs. In the illustrated implementation, the orientation arbitrator 268 is a neural network classifier that receives the outputs of the three neural network classifiers 262, 264, and 266 and classifies the envelope into one of four possible orientations.

Once an orientation for the envelope has been determined, a second stage of processing can begin. During the second stage of processing, one or more primary image analysis elements 270, various secondary analysis elements 280, and a ranking element 290 can initiate to provide more detailed information as to the contents of the envelope. In accordance with an aspect of the present invention, the second stage is operative to run in approximately two thousand two hundred milliseconds. It will be appreciated that during this time, processor resources can be shared among a plurality of envelopes.

The primary image analysis elements 270 are operative to determine one or more of indicia type, indicia value, and routing information for the envelope. Accordingly, a given primary image analysis element 270 can include a plurality segmentation routines and pattern recognition classifiers that are operative to recognize postal indicia, extract value information, isolate address data, and read the characters comprising at least a portion of the address. It will be appreciated that multiple primary analysis elements 270 can analyze the envelope content, with the results of the multiple analyses being arbitrated at the ranking element 290.

The secondary analysis elements 280 can include a plurality of classification algorithms that review specific aspects of the envelope. In the illustrated implementation, the plurality of classification algorithms can include a stamp recognition classifier 282 that identifies stamps on an envelope via template matching, a metermark recognition system 283, a metermark value recognition system 284 that locates and reads value information within metermarks, one or more classifiers 285 that analyze an ultraviolet florescence image, and a classifier 286 that identifies and reads information based indicia (ISI).

It will be appreciated that the secondary analysis elements 280 can be active or inactive for a given envelope according to the results at the second and third neural networks 264 and 266. For example, if it is determined with high confidence that the envelope contains only a stamp, the metermark recognition element 283, metermark value recognition element 284, and the IBI based recognition element 286 can remain inactive to conserve processor resources.

The outputs of the orientation determination element 260, the primary image analysis elements 270, and the secondary analysis elements 280 are provided to a ranking element 290 that determines a final output for the system 250. In the illustrated implementation, the ranking element 290 is a rule based arbitrator that determines at least the type, location, value, and identity of any indicia on the envelope according to a set of predetermined logical rules. These rules can be based on known error rates for the various analysis elements 260, 270, and 280. The output of the ranking element 290 can be used for decision making throughout the mail handling system.

FIG. 7 illustrates a computer system 300 that can be employed to implement systems and methods described herein, such as based on computer executable instructions running on the computer system. The computer system 300 can be implemented on one or more general purpose networked computer systems, embedded computer systems, routers, switches, server devices, client devices, various intermediate devices/nodes and/or stand alone computer systems. Additionally, the computer system 300 can be implemented as part of the computer-aided engineering (CAE) tool running computer executable instructions to perform a method as described herein.

The computer system 300 includes a processor 302 and a system memory 304. Dual microprocessors and other multi-processor architectures can also be utilized as the processor 302. The processor 302 and system memory 304 can be coupled by any of several types of bus structures, including a memory bus or memory controller, a peripheral bus, and a local bus using any of a variety of bus architectures. The system memory 304 includes read only memory (ROM) 308 and random access memory (RAM) 310. A basic input/output system (BIOS) can reside in the ROM 308, generally containing the basic routines that help to transfer information between elements within the computer system 300, such as a reset or power-up.

The computer system 300 can include one or more types of long-term data storage 314, including a hard disk drive, a magnetic disk drive, (e.g., to read from or write to a removable disk), and an optical disk drive, (e.g., for reading a CD-ROM or DVD disk or to read from or write to other optical media). The long-term data storage can be connected to the processor 302 by a drive interface 316. The long-term storage components 314 provide nonvolatile storage of data, data structures, and computer-executable instructions for the computer system 300. A number of program modules may also be stored in one or more of the drives as well as in the RAM 310, including an operating system, one or more application programs, other program modules, and program data.

A user may enter commands and information into the computer system 300 through one or more input devices 320, such as a keyboard or a pointing device (e.g., a mouse). These and other input devices are often connected to the processor 302 through a device interface 322. For example, the input devices can be connected to the system bus 306 by one or more a parallel port, a serial port or a universal serial bus (USB). One or more output device(s) 324, such as a visual display device or printer, can also be connected to the processor 302 via the device interface 322.

The computer system 300 may operate in a networked environment using logical connections (e.g., a local area network (LAN) or wide area network (WAN) to one or more remote computers 330. The remote computer 330 may be a workstation, a computer system, a router, a peer device or other common network node, and typically includes many or all of the elements described relative to the computer system 300. The computer system 300 can communicate with the remote computers 330 via a network interface 332, such as a wired or wireless network interface card or modem. In a networked environment, application programs and program data depicted relative to the computer system 300, or portions thereof, may be stored in memory associated with the remote computers 330.

It will be understood that the above description of the present invention is susceptible to various modifications, changes and adaptations, and the same are intended to be comprehended within the meaning and range of equivalents of the appended claims. The presently disclosed embodiments are considered in all respects to be illustrative, and not restrictive. The scope of the invention is indicated by the appended claims, rather than the foregoing description, and all changes that come within the meaning and range of equivalence thereof are intended to be embraced therein.

Having described the invention, we claim the following:

1. A method for determining the orientation of an envelope, comprising:
analyzing at least one envelope image to produce a first output that is indicative of the orientation of the envelope;
locating at least one postal indicia present on the envelope;
analyzing the located at least one postal indicia to produce a second output; and
determining an associated orientation of the envelope according to the first output and the second output.

2. The method of claim 1, wherein analyzing at least one envelope image comprises analyzing a binarized envelope image according to a distribution of dark pixels across the envelope image.

3. The method of claim 1, wherein locating at least one postal indicia present on the envelope comprises searching a plurality of regions of interest on the at least one envelope image.

4. The method of claim 3, wherein locating at least one postal indicia present on the envelope comprises reviewing the regions of interest within at least one binarized envelope image for regions having a high density of dark pixels.

5. The method of claim 1, wherein determining an associated orientation of the envelope comprises providing the first output and the second output as inputs to a neural network classifier.

6. The method of claim 1, wherein determining an associated orientation for the envelope comprises classifying the envelope into one of a first orientation of the front of the envelope, a second orientation of the front of the envelope that is rotated one hundred eighty degrees from the first orientation, a third orientation where the envelope is flipped, such that the envelope image represents the back of the envelope, and a fourth orientation where the envelope is rotated one hundred eighty degrees from the third orientation.

7. The method of claim 1, wherein analyzing at least one envelope image comprises analyzing first and second envelope images and classifying each of the first envelope image and the second envelope image into one of three output classes including a first class representing an arbitrary default orientation of the front of the envelope, a second class representing an orientation of the front of the envelope that is rotated one hundred eighty degrees from the default orientation, and a third class representing an orientation where the envelope image represents the back of the envelope, such that the first output comprises respective classification results for each of the first and second envelope images.

8. A computer program product, operative in a data processing system and stored on a computer readable medium, that determines an orientation of an envelope comprising:
a plurality of classification elements, each operative to analyze at least one image of the envelope and produce at least one output value indicative of the orientation of the envelope; and
a neural network arbitrator that determines an associated orientation for the envelope according to the plurality of output values provided by the plurality of classification elements.

9. The computer program product of claim 8, the plurality of classification elements comprising an indicia recognition element that classifies each of a plurality of regions of interest associated with the at least one image of the envelope to produce a set of output values for each region of interest representing the likelihood that the region of interest contains one of a plurality of classes of postal indicia.

10. The computer program product of claim 9, wherein the indicia recognition element comprises a neural network that receives a set of feature values associated with each region of interest and outputs a set of output values representing a stamp class, a metermark class, a business reply mail class, an information based indicia class, a blank region class, and an other class.

11. The computer program product of claim 8, the plurality of classification elements comprising an orientation recognition element that classifies each of first and second images from the at least one image of the envelope to produce a set of output values for each image representing possible orientations of the envelope.

12. The computer program of claim 11, wherein the orientation recognition element comprises a neural network classifier that receives a set of feature values associated each of the first and second images and classifies each image into one of three output classes including a first class representing an arbitrary default orientation of the front of the envelope, a second class representing an orientation of the front of the envelope that is rotated one hundred eighty degrees from the default orientation, and a third class representing an orientation where the envelope image represents the back of the envelope.

13. The computer program of claim 8, the plurality of classification elements comprising an indicia detection and recognition element that locates postal indicia within a plurality of regions of interest associated with the at least one image of the envelope and classifies any located postal indicia to produce a set of output values for each region of interest representing the likelihood that the region of interest contains one of a plurality of classes of postal indicia.

14. The computer program product of claim 13, the indicia detection and recognition element comprising a neural network classifier that receives a set of feature values associated with each region of interest and outputs a set of output values representing a stamp class, a metermark class, a business reply mail class, an information based indicia class, a blank region class, and an other class.

15. An arbitration system that determines an associated orientation of an envelope, comprising:
an image acquisition element that produces a first envelope image, representing a first side of the envelope, and a second envelope image, representing a second side of the envelope;
a first classification system that classifies each of a plurality of regions of interest associated with the first and second envelope images to produce a set of output values for each region of interest representing the likelihood that the region of interest contains one of a plurality of classes of postal indicia;
a second classification system that classifies each of the first and second envelope images to produce a set of output values for each envelope image representing possible orientations of the envelope; and
an arbitration system that receives the set of output values associated with each region of interest from the first classification system and the set of output values associated with each envelope image from the second classification system and determines an associated orientation for the envelope according to the received sets of output values from the first and second classifiers.

16. The system of claim 15, wherein the first classification system comprises a neural network classifier that receives a set of feature values associated with each region of interest and outputs a set of output values representing a stamp class, a metermark class, a business reply mail class, an information based indicia class, a blank region class, and an other class.

17. The system of claim 15, wherein the second classification system comprises a neural network classifier that receives a set of feature values associated each envelope image and classifies each image into one of three output classes including a first class representing an arbitrary default orientation of the front of the envelope, a second class representing an orientation of the front of the envelope that is rotated one hundred eighty degrees from the default orientation, and a third class representing an orientation where the envelope image represents the back of the envelope.

18. The system of claim 15, the arbitration system comprising a neural network classifier that receives the outputs of the first and second classification systems and classifies the envelope into one of four orientation classes representing, respectively, a first orientation of the front of the envelope, a second orientation of the front of the envelope that is rotated one hundred eighty degrees from the first orientation, a third orientation where the envelope is flipped, such that the envelope image represents the back of the envelope, and a fourth orientation where the envelope is rotated one hundred eighty degrees from the third orientation.

19. The system of claim 15, further comprising a third classification system that locates postal indicia within a plurality of regions of interest associated with the first and second envelope images and classifies any located postal indicia to produce a set of output values for each region of interest representing the likelihood that the region of interest contains one of a plurality of classes of postal indicia, an arbitration system receiving the outputs of the first, second, and third classification systems.

20. The system of claim 19, the third classification system comprising a neural network classifier that receives set of feature values associated with each region of interest and outputs a set of output values representing a stamp class, a metermark class, a business reply mail class, an information based indicia class, a blank region class, and an other class.
